(19) United States
(12) Patent Application Publication
(10) Pub. No.: US 2009/0142585 A1
(43) Pub. Date: Jun. 4, 2009

(54) Nanocomposite compositions of polyamides, sepiolite-type clays and copper species and articles thereof

(76) Inventors: Toshikazu Kobayashi, Chadds Ford, PA (US); Gloria Jean Jones, Fort Collins, CO (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/290,964

(22) Filed: Nov. 5, 2008

Related U.S. Application Data
(60) Provisional application No. 61/002,372, filed on Nov. 8, 2007.

(51) Int. Cl. B32B 5/16; C08K 3/34; B82B 1/00

(52) U.S. Cl. 428/328; 524/413; 524/425; 977/700; 977/773

(57) ABSTRACT

The invention is directed to nanocomposite compositions that contain at least one thermoplastic polyamide; unmodified sepiolite-type clay nanoparticles; and a copper species. It, also, includes articles containing such compositions.

### CROSS REFERENCE TO RELATED APPLICATIONS

This application claims the benefit of priority to U.S. Provisional Application No. 61/002,372, filed Nov. 8, 2007.

### FIELD OF INVENTION

This invention is directed to nanocomposites comprising thermoplastic polyamides, unmodified sepiolite-type clay nanoparticles and copper heat stabilizers. The invention, also, includes articles made the nanocomposites.

### BACKGROUND OF INVENTION

Nanocomposites are compositions that satisfy many of the challenges currently presented by automotive plastics and composites needs. Nanocomposite compositions are polymers reinforced with nanometer sized particles (“nanoparticles”), i.e., typically particles with a dimension on the order of 1 to several hundred nanometers. These materials can be used in structural, semi-structural, high heat underhood, and Class A automotive components, among others.

Injection moldable thermoplastics have long been mechanically reinforced with an addition of particulate and fiber fillers in order to improve mechanical properties such as stiffness, dimensional stability, and temperature resistance. Typical fillers include chopped glass fiber and talc, which are added at filler loadings of 20-40% in order to obtain significant mechanical reinforcement. At these loading levels, however, low temperature impact performance and material toughness are usually sacrificed. Polymer-silicate nanocomposite materials, in other words, compositions in which the silicate is dispersed as very small particles, can address these issues.

Polymer-layered silicate nanocomposites normally incorporate a layered clay mineral filler in a polymer matrix. Layered silicates are made up of several hundred thin platelet layers stacked into an orderly packet known as a tactoid. Each of these platelets is characterized by large aspect ratio (diameter/thickness on the order of 100-1000). Accordingly, when the clay is dispersed homogeneously and exfoliated as individual platelets throughout the polymer matrix, dramatic increases in strength, flexural and Young's modulus, and heat distortion temperature are observed at very low filler loadings (<10% by weight) because of the large surface area contact between polymer and filler.

Clay minerals and their industrial applications are reviewed by H. M. Murray in Applied Clay Science 17 (2000) 207-221. Two types of clay minerals are commonly used in nanocomposites: kaolin and smectite. The molecules of kaolin are arranged in two sheets or plates, one of silica and one of alumina. The most widely used smectites are sodium montmorillonite and calcium montmorillonite. Smectites are arranged in two silica sheets and one alumina sheet. The molecules of the montmorillonite clay minerals are less firmly linked together than those of the kaolin group and are thus further apart.

Polyamide nanocomposites typically combine a polyamide with an inorganic layered silicate, usually a smectite clay The alkali and alkaline earth ions in the layered silicate are exchanged with onium ions, typically alkyl ammonium ions from alkylammonium salts (for example octadecylammonium chloride or a quaternary ammonium tallow), or ω-amino acids (for example, 12-aminolauric acid) in order to facilitate intercalation and subsequent exfoliation. Clays that have been so treated are often referred to as “(organically) modified clays” or “organoclays.”. However, these compounds are not thermally stable enough to be used with those polyamides that are compounded high temperatures, particularly semi-aromatic polyamides.

Polyamide nanocomposites have been prepared via melt compounding (also referred to as “melt mixing”). In Japanese Patent Application H02[1990]-182758, Oda et al. melt compounded 15 and 30 wt % of sepiolite into polyamide 6 after drying the sepiolite for 24 h at 100° C. It describes the fiber diameter of the sepiolite as ordinarily about 0.05 to 0.3 μm, and the fiber length, about 1 to 100 μm. No particular restriction on the fiber diameter or the fiber length of the sepiolite is disclosed, but it is disclosed that sepiolite with a fiber diameter of about 0.1 to 0.2 μm and a fiber length of about 3 to 30 μm is easy to acquire and offers excellent results. It is also disclosed that the use of less than 5 wt % sepiolite does not achieve improvement in the properties of mechanical strength, heat resistance, and warpage.

Specific optical applications, such as light housings for automobiles, require polyamide composites that have good melt stability, toughness, excellent surface appearance as measured by surface gloss, and excellent anti-fogging performance. Fogging refers to the tendency for a polymer composite to outgas condensable materials when heated over a period of time. The outgassed materials tend to condense on cooler surfaces and can act to fog lamps over a period of time. This is an undesirable attribute. Thus, certain applications such as fog lamp housings and headlight housings, require composites that have low outgassing of condensable materials as well as the other features described above.

For the reasons set forth above, there exists a need for improved polyamide nanocomposites with low concentrations of nanoparticles that can be processed at high temperatures and yield improved properties.

### SUMMARY OF INVENTION

One embodiment of the invention is a nanocomposite composition, comprising
(a) at least one thermoplastic polyamide;
(b) about 0.5 to about 5 wt % of unmodified sepiolite-type clay nanoparticles having widths and thicknesses of less than 50 nm; and
(c) about 0.001 to about 1.0 wt % of a copper species selected from Cu(I), Cu(II), or a mixture thereof; based on the total weight of the nanocomposite composition.

Another embodiment of the invention is an article of manufacture comprising the nanocomposite composition as disclosed above.

### DETAILED DESCRIPTION OF INVENTION

This invention concerns nanocomposite compositions that contain at least one thermoplastic polyamide, unmodified sepiolite-type clay nanoparticles and about 0.01 to about 1.0 wt % of a Cu species. The invention includes articles containing such compositions. As used herein, the term “nanocomposite” or “polymer nanocomposite” or “nanocomposite composition” means a polymeric material that contains nanoparticles dispersed throughout the polymeric material wherein the nanoparticles have at least one dimension less than 50 nm (“nanoparticles”). The term “polyamide composite” refers to a nanocomposite in which the polymeric material includes at least one polyamide. Preferably the nanocomposite comprises at least 50 wt % of at least one thermoplastic polyamide, and more preferably at least 70 wt % of at least one thermoplastic polyamide.

Where a range of numerical values is recited herein, unless otherwise stated, the range is intended to include the endpoints thereof, and all integers and fractions within the range. It is not intended that the scope of the invention be limited to the specific values recited when defining a range.

Sepiolite-Type Clay As used herein, the term “sepiolite-type clay” refers to both sepiolite and attapulgite (palygorskite) clays and mixtures thereof.

Sepiolite-type clays are layered fibrous materials in which each layer is made up of two sheets of tetrahedral silica units bonded to a central sheet of octahedral units containing magnesium ions (see, e.g., Polymer International, 53, 1060-1065 (2004)).

Sepiolite (Mg₄Si₆O₁₅(OH)₂.6(H₂O) is a hydrated magnesium silicate filler that exhibits a high aspect ratio due to its fibrous structure. Unique among the silicates, sepiolite is composed of long lath-like crystallites in which the silica chains run parallel to the axis of the fiber. The material has been shown to consist of two forms, an α and a β form. The α form is known to be long bundles of fibers and the β form is present as amorphous aggregates.

Aftapulgite (also known as palygorskite) is almost structurally and chemically identical to sepiolite except that attapulgite has a slightly smaller unit cell. As used herein, the term “sepiolite-type clay” includes attapulgite as well as sepiolite itself.

Sepiolite-type clays are available in a high purity, unmodified form (e.g., Pangel® S-9 sepiolite clay from the Tolsa Group, Madrid, Spain). Preferably the clay is in the form of a fine particulate, so it may be readily dispersed in the polyamide melt.

The sepiolite-type clays used in the compositions described herein are unmodified. The term “unmodified” means that the surface of the sepiolite-type clay has not been treated with an organic compound such as an onium compound (for example, to make its surface less polar).

Sepiolite-type clay fibers contained in the compositions described herein have a width (x) and thickness (y) of less than 50 nm each, and in addition have a length (z). In an embodiment, the sepiolite-type clay is rheological grade, such as described in European patent applications EP-A-0454222 and EP-A-0170299 and marketed under the trademark Pangel® by Tolsa, S. A., Madrid, Spain. As described therein “rheological grade” denotes a sepiolite-type clay with a specific surface area greater than 120 m²/g (N₂, BET), and typical fiber dimensions: 200 to 2000 nm long, 10-30 nm wide, and 5-10 nm thick.

Rheological grade sepiolite is obtained from natural sepiolite by means of special micronization processes that substantially prevent breakage of the sepiolite fibers, such that the sepiolite disperses easily in water and other polar liquids, and has an external surface with a high degree of irregularity, a high specific surface, preferably greater than 300 m²/g, and a high density of active centers for adsorption. The active centers allow significant hydrogen bonding that provide the rheological grade sepiolite a high water retaining capacity. The microfibrous nature of the rheological grade sepiolite nanoparticles makes sepiolite a material with high porosity and low apparent density.

Additionally, rheological grade sepiolite has a very low cationic exchange capacity (10-20 meq/100 g) and the interaction with electrolytes is very weak, which in turn causes rheological grade sepiolite not to be practically affected by the presence of salts in the medium in which it is found, and therefore, it remains stable in a broad pH range.

The above-mentioned qualities of rheological grade sepiolite can also be attributed to rheological grade attapulgite with particle sizes smaller than 40 microns, such as for example the range of ATTAGEL® goods (for example ATTAGEL® 40 and ATTAGEL® 50 attapulgite) manufactured and marketed by BASF, Florhan Park, N.J. 07932, and the MIN-U-GEL range of Floridin Company.

Preferably, the amount of sepiolite-type clay used in the present invention ranges from about 0.5 to about 5 wt %, most preferably from about 0.5 to about 3 wt % based on the total amount of sepiolite-type clay and polyamide in the final composition. The specific amount chosen will depend on the intended use of the nanocomposite composition, as is well understood in the art. For example, in film, it may be advantageous to use as little sepiolite-type clay as possible, so as to retain desired optical properties. “Masterbatches” of the nanocomposite composition containing relatively high concentrations of sepiolite-type clay may also be used. For example, a nanocomposite composition masterbatch containing 30% by weight of the sepiolite-type clay may be used. If a composition having 3 weight percent of the sepiolite-type clay is needed, the composition containing the 3 weight percent may be made by melt mixing 1 part by weight of the 30% masterbatch with 9 parts by weight of the “pure” polyamide. During this melt mixing, other desired components can also be added to form a final desired composition.

### Polyamides

As used herein, “polyamide” means a condensation polymer in which more than 50 percent of the groups connecting repeat units are amide groups. Thus “polyamide” may include polyamides, poly(ester-amides) and poly(amide-imides), so long as more than half of the connecting groups are amide groups. In one embodiment at least 70% of the connecting groups are amides, in another embodiment at least 90% of the connecting groups are amides, and in another embodiment all of the connecting groups are amides. The proportion of ester connecting groups can be estimated to a first approximation by the molar amounts of monomers used to make the polyamides.

Polyamides suitable for use in the nanocomposites described herein comprise thermoplastic polyamide homopolymers, copolymers, terpolymers, or higher polymers (both block and random). As used herein, the term “thermoplastic polyamide” denotes a polyamide which softens and can be made to flow when heated and hardens on cooling, retaining the shape imposed at elevated temperature. Preferably, such polyamides are aliphatic or semi-aromatic.

### Aliphatic Polyamides

One embodiment is a nanocomposite composition wherein the polyamide is an aliphatic polyamide. Aliphatic polyamides are well known in the art. Methods of production are well known in the art. For example, the polyamide resin(s) can be produced by condensation of equimolar amounts of saturated dicarboxylic acid containing from 4 to 12 carbon atoms with a diamine, in which the diamine contains from 4 to 14 carbon atoms. Excess diamine can be employed to provide an excess of amine end groups in the polyamide. Suitable aliphatic polyamides for various embodiments include but are not limited to poly(tetramethylene adipamide) (polyamide 4,6), poly(hexamethylene adipamide) (polyamide 6,6), poly(hexamethylene azelaamide) (polyamide 6,9), poly(hexamethylene sebacamide) (polyamide 6,10), poly(hexamethylene dodecanoamide) (polyamide 6,12), bis(para-aminocyclohexyl)methane dodecanoamide, and the like. Aliphatic polyamides can also be produced by ring opening polymerization of lactams, such as ε-caprolactam (polycaprolactam, also known as polyamide 6) and poly-11-amino-undecanoic acid (polyamide 11). It is also possible to use polyamides prepared by the copolymerization of two of the above polymers or terpolymerization of the above polymers or their components. Examples of copolycondensation polyamides include polyamide 6/66, polyamide 6/610, polyamide 6/12, polyamide 6/46, and the like. Among the aliphatic polyamides, polyamide 6 and 6,6 are preferred for the nanocomposite compositions.

### Semi-Aromatic Polyamides

Thermoplastic semi-aromatic polyamides are particularly preferred for the nanocomposites described herein. As used herein, “semi-aromatic polyamide” means a polyamide containing both divalent aromatic groups and divalent non-aromatic groups. As used herein, “a divalent aromatic group” means an aromatic group with links to other parts of the polyamide molecule. For example, a divalent aromatic group may include a meta- or para-linked monocyclic aromatic group. Preferably the free valencies are to aromatic ring carbon atoms.

Semi-aromatic polyamides are well known in the art. The thermoplastic semi-aromatic polyamide may be one or more homopolymers, copolymers, terpolymers, or higher polymers that are derived in part from monomers that contain divalent aromatic groups. It may also be a blend of one or more aliphatic polyamides with one or more homopolymers, copolymers, terpolymers, or higher polymers that are derived in part from monomers containing divalent aromatic groups.

Preferred monomers containing divalent aromatic groups are terephthalic acid and its derivatives, isophthalic acid and its derivatives, and m-xylylenediamine. It is preferred that about 5 to about 75 mole percent of the monomers used to make the semi-aromatic polyamide used in the nanocomposites described herein contain divalent aromatic groups, and more preferred that about 10 to about 55 mole percent of the monomers contain divalent aromatic groups. Thus, preferably, about 5 to about 75 mole percent, or more preferably, 10 to about 55 mole percent of the repeat units of all polyamides used in the nanocomposites described herein contain divalent aromatic groups.

The semi-aromatic polyamide may optionally contain repeat units derived from one or more additional aliphatic dicarboxylic acid monomers or their derivatives, such as adipic acid, sebacic acid, azelaic acid, dodecanedioic acid, and other aliphatic or alicyclic dicarboxylic acid monomers having 6 to 20 carbon atoms. As used herein, “alicyclic” means a divalent non-aromatic hydrocarbon group containing a cyclic structure therein.

The semi-aromatic polyamide may optionally contain repeat units derived from one or more aliphatic or alicyclic diamine monomers having 4 to 20 carbon atoms. Preferred aliphatic diamines may be linear or branched and include hexamethylenediamine; 2-methyl-1,5-pentanediamine; 1,8-diaminooctane; 1,9-diaminononane; methyl-1,8-diaminooctane; 1,10-diaminodecane; and 1,12-diaminododecane. Examples of alicyclic diamines include 1-amino-3-aminomethyl-3,5,5,-trimethylcyclohexane; 1,4-bis(aminomethyl)cyclohexane; and bis(p-aminocyclohexyl)methane.

The semi-aromatic polyamide may optionally contain repeat units derived from lactams and aminocarboxylic acids (or acid derivatives), such as caprolactam, 11-aminoundecanoic acid, and laurylactam.

Examples of preferred semi-aromatic polyamides include poly(m-xylylene adipamide) (polyamide MXD,6); hexamethylene adipamide/hexamethylene terephthalamide copolyamide (polyamide 6,T/6,6); hexamethylene terephthalamide/2-methylpentamethylene terephthalamide copolyamide (polyamide 6,T/D,T); poly(dodecamethylene terephthalamide) (polyamide 12,T); poly(decamethylene terephthalamide) (polyamide 10,T); decamethylene terephthalamide/decamethylene dodecanoamide copolyamide (polyamide 10,T/10, 12); poly(nonamethylene terephthalamide) (polyamide 9,T); the polyamide of hexamethylene isophthalamide and hexamethylene adipamide (polyamide 6,I/6,6); the polyamide of hexamethylene terephthalamide, hexamethylene isophthalamide, and hexamethylene adipamide (polyamide 6,T/6,I/6,6); and copolymers and mixtures of these polymers.

The semi-aromatic polyamide will preferably have a melting point that is at least about 280° C. and is preferably less than about 340° C.

Among the semi-aromatic polyamides, hexamethylene adipamide/hexamethylene terephthalamide copolyamide (polyamide 6,T/6,6) and hexamethylene terephthalamide/2-methylpentamethylene terephthalamide copolyamide (polyamide 6,T/D,T) are preferred.

### Copper Species

The nanocomposite composition comprises about 0.001 to about 1.0 wt % of a copper species selected from Cu(I), Cu(II), or a mixture thereof, preferably about 0.01 to about 0.5 wt % of the copper species, based on the total weight of the nanocomposite composition. The above weight percent range of copper species includes the weight of the copper species only, and is not meant to include the weight of the counter ion, for instance, halide, acetate, oxide, etc. The counter ion weight is included in the calculation of the total nanocomposite weight. In an embodiment the copper species is selected from the group consisting of copper iodide, copper bromide, copper chloride, copper fluoride; copper thiocyanate, copper nitrate, copper acetate, copper naphthenate, copper caprate, copper laurate, copper stearate, copper acetylacetonate, and copper oxide. In another embodiment the copper species is a copper halide selected from copper iodide, copper bromide, copper chloride, and copper fluoride. A preferred copper species is copper iodide.

Another embodiment is a nanocomposite composition, as disclosed above, additionally comprising about 0.01 to about 1.0 wt % of an metal halide salt selected from LiI, NaI, KI, MgI₂, KBr, and CaI₂. In another embodiment the metal halide is KI or KBr.

### Solid Particulate Fillers (Exclusive of the Sepiolite-Type Clay)

As used herein, “a solid particulate filler exclusive of the sepiolite-type clay” means any solid (infusible at temperatures to which the composition is normally exposed) that is finely divided enough to be dispersed under melt mixing conditions (see below) into the composition.

Solid particulate fillers must be finely divided enough to be dispersed under melt mixing conditions (see below) into the composition. Typically, the solid particulate filler will be a material typically used in thermoplastic compositions, such as pigments, reinforcing agents, flame retardants, and fillers. The solid particulate filler may or may not have a coating on it, for example, a sizing and/or a coating to improve adhesion of the solid particulate filler to the polymers of the composition. The solid particulate filler may be organic or inorganic.

In one embodiment the nanocomposite further comprises about 0.1 to about 50 weight percent, based on the total of all ingredients in the composition, of a reinforcing agent, exclusive of the sepiolite-type clay, selected from: kaolin clay, talc, wollastonite, mica, calcium carbonate, glass fibers, milled glass, solid and hollow glass spheres, carbon black, carbon fiber; titanium dioxide, aramid fibers, fibrils and fibrids, and mixtures thereof. These reinforcing agents may be coated with adhesion promoters or other materials which are commonly used to coat reinforcing agents used in thermoplastics.

Typical flame retardants include brominated polystyrene, brominated polyphenylene oxide, red phosphorus, magnesium hydroxide, and magnesium carbonate. These are typically used with flame retardant synergists, such as antimony pentoxide, antimony trioxide, sodium antimonate or zinc borate.

The solid particulate material may be conventionally melt mixed with the nanocomposite, for example, in a twin screw extruder or Buss kneader. It may be added at the same time as the sepiolite-type clay, although if a lot of particulate material is added it may increase the viscosity, and care should be taken not to increase the viscosity too high.

The solid particulate material exclusive of the sepiolite-type clay may be present at 0 to about 60 weight percent of the total composition.

### Polymeric Toughening Agents

Improvement of impact strength, or toughness, of polyamide resins has long been of interest. Resistance to shattering or brittle breaking on impact of polyamide molded articles is a desirable feature of any molded article. Any tendency to break on impact in a brittle fashion (rather than ductile fashion) is a significant limitation on the usefulness of such articles. Breaks in ductile materials are characterized more by tearing with a large volume of adjacent material yielding at the edge of the crack or tearing rather than a sharp, clean break with little molecular displacement. A resin having good ductility is one that is resistant to crack propagation caused by impact.

Thus, a preferred optional ingredient in the nanocomposite compositions is a polymeric toughening agent. One type of polymeric toughening agent is a polymer, typically though not necessarily an elastomer, which has attached to it functional groups which can react with the polyamide (and optionally other polymers present) to produce a compounded multiphase resin with improved impact strength versus the untoughened polyamide. Some functional groups that can react with polyamides are carboxyl (—COOH), metal-neutralized carboxyl, amine, anhydride, epoxy, and bromine. Since polyamides usually have carboxyl (—COOH) and amine groups present, these functional groups usually can react with carboxyl and/or amine groups. Such functional groups are usually “attached” to the polymeric toughening agent by grafting small molecules onto an already existing polymer or by copolymerizing a monomer containing the desired functional group when the polymeric toughener molecules are made by copolymerization. As one example of grafting, maleic anhydride may be grafted onto a hydrocarbon rubber using free radical grafting techniques. The resulting grafted polymer has carboxylic anhydride and/or carboxyl groups attached to it.

A variety of additives have been added to polyamide resins to improve strength and ductility. For example, U.S. Pat. No. 4,174,358, herein incorporated by reference, describes improving impact strength and ductility by adding a selected random copolymer which adheres to the polyamide. U.S. Pat. No. 5,112,908, herein incorporated by reference, teaches that in certain polymeric toughening agents for polyamides, the sites that promote adhesion with polyamide (“graft sites”) preferably will be present as metal-neutralized carboxyl, adjacent carboxyl (i.e., a carboxylic acid monomer unit adjacent to a metal-neutralized carboxyl monomer unit), anhydride, or epoxy functional groups, but other functional sites such as sulfonic acid or amine may be effective. These sites will be present in amounts that provide the requisite grafting.

A preferred polymeric toughening agent is a copolymer of ethylene, propylene and 1,4-hexadiene and, optionally, norbornadiene, said copolymer having grafted thereto an unsaturated monomer taken from the class consisting of fumaric acid, maleic acid, maleic anhydride, the monoalkyl ester of said acids in which the alkyl group of the ester has 1 to 3 carbon atoms. For example, one such polymer is TRX 301, available from the Dow Chemical Company (Midland, Mich., USA).

Another type of polymeric toughening agent is an ionomer that contains certain types of ionic groups. The term “ionomer” as used herein refers to a polymer with inorganic salt groups attached to the polymer chain (Encyclopedia of Polymer Science and Technology, 2nd ed., H. F. Mark and J. I. Kroschwitz eds., vol. 8, pp. 393-396). Ionomers that act as polyamide toughening agents contain ionic groups which do not necessarily react with the polyamide but toughen through the compatibility of those ionic groups with the polyamide, which is caused by the solubility of the ions (for example, lithium, zinc, magnesium, and manganese ions) in the polyamide melt. A preferred polymeric toughening agent of this type is an ionomer of units derived from alpha-olefin having the formula RCH═CH₂ wherein R is H or alkyl having from 1 to 8 carbon atoms and from 0.2 to 25 mole percent of units derived from an alpha, beta-ethylenically unsaturated mono- or dicarboxylic acid, at least 10% of the acid groups of said units being neutralized by metal ions having a valence of from 1 to 3, inclusive. Preferably, the ionomer will be a copolymer of ethylene and acrylic or methacrylic acid at least 10% neutralized by metal ions such as Li⁺, Zn⁺², Mg⁺², and/or Mn⁺². For example, one such polymer is DuPont™ Surlyn® ionomer (E. I. du Pont de Nemours & Co., Inc., Wilmington, Del., USA).

In addition to the polymeric toughening agents described above, two halogenated elastomers have been identified as effective toughening agents for polyamides, namely, a halogenated isobutylene-isoprene copolymer, and a brominated poly(isobutylene-co-4-methylstyrene). The latter is commercially available as Exxpro specialty elastomer from Exxon Mobil Chemical (Houston, Tex., USA).

In an embodiment there is about 2 to about 30 weight percent of the polymeric toughener in the composition, in another embodiment 5 to about 25 weight percent, and in another embodiment about 8 to about 20 weight percent, of the total composition.

The polymeric toughening agent may comprise a mixture of 2 or more polymers, at least one of which must contain reactive functional groups or ionic groups as described above. The other(s) may or may not contain such functional groups or ionic groups. For instance, a preferred polymeric toughening agent for use in the compositions described herein comprises a mixture of an ethylene/propylene/hexadiene terpolymer grafted with maleic anhydride and a plastomeric polyethylene such as Engage® 8180, an ethylene/1-octene copolymer available from the Dow Chemical Company (Midland, Mich., USA).

The compositions disclosed herein further include those wherein the at least one thermoplastic polyamide (a) is selected from polyamide 6,6; polyamide 6; a copolyamide of terephthalic acid, hexamethylenediamine, and 2-methyl-pentamethylenediamine; a copolyamide made from terephthalic acid, adipic acid, and hexamethylenediamine; the Cu species (c) is present in an amount from about 0.01 to about 1.0 wt %; and wherein the composition further comprises (d) 0 to about 20 wt % polymeric toughening agent comprising at least one of
(i) an ethylene/propylene/hexadiene copolymer grafted with maleic anhydride; and
(ii) a copolymer of ethylene and acrylic or methacrylic acid that is at least 10% neutralized by metal ions

wherein the weight percentages are based on the total weight of the nanocomposite composition.

### Additives

Other ingredients, particularly those commonly used in thermoplastics, may optionally be added to the present composition in amounts commonly used in thermoplastics. Such materials include antioxidants, antistatic additives, lubricant, mold release, (paint) adhesion promoters, other types of polymers (to form polymer blends), etc. Preferably the total of all these ingredients is less than about 60 weight percent, more preferably less than about 40, and especially preferably less than about 25 weight percent of the composition.

### Melt Mixing

The compositions described herein can be made by typical melt mixing techniques. For instance, the ingredients may be added to a single or twin screw extruder or a kneader and mixed in the normal manner. After the materials are mixed, they may be formed (cut) into pellets or other particles suitable for feeding to a melt forming machine. Melt forming can be carried out by the usual methods for thermoplastics, such as injection molding, thermoforming, or extrusion, or any combination of these methods. Some of the ingredients such as the copper species, fillers, plasticizers, and lubricants (mold release) may be added at one or more downstream points in the extruder, so as to decrease attrition of solids such as fillers, and/or improve dispersion, and/or decrease the thermal history of relatively thermally unstable ingredients, and/or decrease losses by evaporation of volatile ingredients.

The sepiolite-type clay may be melt mixed directly with the other ingredients at its desired final concentration. Alternatively, a masterbatch containing a relatively high concentration of sepiolite-type clay (e.g., 20-30 wt % in the polyamide(s) of choice) may be prepared by melt-mixing, and then the masterbatch is in turn melt mixed with additional ingredients to achieve the final composition.

It is also noted that “melt mixing” or, more precisely, applying shear stress to a melt of a polyamide/sepiolite-type clay nanocomposite sometimes results in better dispersion of the nanoparticles in the already formed nanocomposite. Thus, post-treatment of the initially formed nanocomposite by shearing of the melt is a preferred process. This can be a process simply dedicated to improving the dispersion or, more preferably, occur when the polyamide composite is liquefied and subject to shear for another reason, such as mixing in other materials and or melt forming the nanocomposite composition. Useful types of apparatuses for this purpose include single and twin screw extruders and kneaders.

It has also been found that the mixing intensity [for example, as measured by extruder speed (revolutions per minute, rpm)] may affect the properties of the composition, especially toughness. While relatively higher rpm are preferred, the toughness may decrease at too high a mixer rotor speed. The optimum mixing intensity depends on the configuration of the mixer, the temperatures, compositions, etc. being mixed, and is readily determined by simple experimentation.

It is to be understood that any preferred ingredient and/or ingredient amount may be combined with any other preferred ingredient and/or ingredient amount herein.

Parts comprising the present composition may be made by heating the composition above the melting point (or glass transition temperature if the polyamide is amorphous) of the polyamide (and hence liquefying the polyamide), and then cooling them below the melting point to solidify the composition and formed a shaped part. Preferably, the part is cooled at least 50° C. below the melting point, more preferably at least 100° C. below the melting point. Most commonly, ultimately the composition will be cooled to ambient temperature, most typically 1545° C.

Articles comprising the nanocomposite compositions may be prepared by any means known in the art, such as, but not limited to, methods of injection molding, melt spinning, extrusion, blow molding, thermoforming, or film blowing.

The nanocomposite compositions described herein enhance such properties as tensile strength and modulus, and provide significantly improved; fogging characteristics; while maintaining good melt viscosity retention of the polyamide nanocomposite.

### Applications

Application areas for the nanocomposites described therein include but are not limited to components in automotive, electrical/electronic, consumer goods, and industrial applications. The nanocomposites described herein that contain semi-aromatic polyamide are especially useful for automotive parts that will be exposed to high temperatures, such as underhood automotives applications, and high-temperature electrical/electronic applications.

In the automotive area, the nanocomposites described herein can be used in applications such as, underhood applications (for example, radiator end tanks, connectors, air intake manifolds, air induction resonators, front end modules, engine cooling water outlets, fuel rails, ignition coils, engine covers), in the interior (for example, switches, handles, seat belt components, air bag containers, pedals, pedal boxes, seat systems), and in exterior applications (for example, bezel, fog lamp housing, wheel covers, sun roof surrounds, door handles, fuel filler flaps).

In the electrical/electronics area, the nanocomposites described herein can be used in applications such as connectors, coil formers, motor armature insulators, light housings, plugs, switches, switchgear, housings, relays, circuit breaker components, terminal strips, printed circuit boards, and housings for electronic equipment.

In the consumer goods area, the nanocomposites described herein can be used in applications such as power tool housings, sports equipment articles (for example, ski boots, ski bindings, ice skates, roller skates, tennis rackets), lighters, kitchen utensils, phone jacks, small appliances (for example, steam iron needles), large appliances (for example, oven fans and glass holders), furniture (for example, chair bases and arms), eyeglass frames, and packaging film.

In the industrial area, the nanocomposites described herein can be used in applications such as gears, pulley, bearings and bearing cages, valves, stadium seats, sliding rails for conveyers, castors, HVAC boiler manifold and diverting valves, and pump housings.

### EXAMPLES

The present invention is further defined in the following Examples. It should be understood that these Examples, while indicating preferred embodiments of the invention, are given by way of illustration only.

The meaning of abbreviations is as follows: “mm” means millimeter(s), “min” means minute(s), “sec” means second(s), “hr” means hour(s), “Kg” means Kilogram(s), “wt %” means weight percent(age), “M” means molar, “Mₙ” means number average molecular weight, “PDI” means polydispersity index and equals the weight average molecular weight divided by Mₙ, “Pa” means pascal(s), “MPa” means megapascal(s), “TEM” means transmission electron microscopy, “rpm” means revolutions per minute.

### Materials Glossary:

Aluminum stearate, a lubricant, was purchased from Chemtura Corporation (199 Benson Rd, Middlebury, Conn. 06749).

Engage® polyolefin elastomers were provided by E. I. du Pont de Nemours & Co., Inc. (Wilmington, Del., USA) and are currently manufactured by the Dow Chemical Company (Midland, Mich., USA). Engage® 8180 is an ethylene/1-octene copolymer with 42 wt % comonomer.

HS 7.1.1 S, a heat stabilizer consisting of 7 parts potassium iodide, 1 part copper (I) iodide and 1 part aluminum distearate was purchased from Shepherd Chemical Co. (Shepherd Norwood, 4900 Beech Street, Norwood, Ohio 45212)

Irganox® 1010 antioxidant was purchased from Ciba Specialty Chemicals (Tarrytown, N.Y., USA).

Licowax® PED 521 is an oxidized polyethylene wax used as a mold lubricant available from Clariant Corp. (Charlotte, N.C. 28205, USA). It is reported to have an acid value of about 18 mg KOH/g wax.

M10 52 Talc was purchased from Minerals Technologies Inc. (New York, N.Y., USA).

Nyad® 5000 wollastonite is a trademarked product of NYCO Minerals, Willsboro, N.Y. 12996.

Pangel® S-9, was purchased from EM Sullivan Associates, Inc. (Paoli, Pa., USA), a distributor for the manufacturer, Tolsa S. A. (Madrid 28001, Spain). Pangel® S-9 is a rheological grade of sepiolite that has an unmodified surface and has been micronized, followed by a second dry grinding process.

TRX 301, an ethylene/propylene/hexadiene terpolymer grafted with 2.1% maleic anhydride, was provided by E. I. du Pont de Nemours & Co., Inc. (Wilmington, Del., USA).

Three polyamides were provided by E. I. du Pont de Nemours & Co., Inc. (Wilmington, Del., USA):

Polyamide A Is a copolyamide of terephthalic acid, hexamethylenediamine, and 2-methyl-pentamethylenediamine where the two diamines are used in a 1:1 molar ratio.

Polyamide B is a copolyamide made from terephthalic acid, adipic acid, and hexamethylenediamine; wherein the two acids are used in a 55:45 molar ratio; having a melting point of ca. 310° C.

Zytel® 101 polyamide is unreinforced polyamide 6,6.

### Test Methods

Molecular weight determination. A size exclusion chromatography system comprised of a Model Alliance 2690™ from Waters Corporation (Milford, Mass.), with a Waters 410™ refractive index detector (DRI) and Viscotek Corporation (Houston, Tex.) Model T-60ATM dual detector module incorporating static right angle light scattering and differential capillary viscometer detectors were used for molecular weight characterization. The mobile phase was 1,1,1,3,3,3-hexafluoro-2-propanol (HFIP) with 0.01 M sodium trifluoroacetate. The dn/dc was measured for the polymers and it was assumed that all of the sample was completely eluted during the measurement.
Melt viscosity retention. Melt viscosity retention (MVR) is defined as the % viscosity retained in a heated sample at a 25 min time interval as compared to the viscosity at 5 min time interval, the sample being heated to a constant specified temperature. The melt viscosity was measured at a shear rate of 1000 sec⁻¹ at 320° C. using a capillary rheometer Galaxy V Model: 5052 manufactured by Kayness, Inc., Morgantown, Pa. The ratio of the 25 min melt viscosity to the 5 min melt viscosity multiplied by 100% gives the % MVR.
Condensable Fogging Test for Automotive Lighting Applications. This test measures the degree of outgassing of a test sample when heated to a specified temperature for a period of time. A test specimen is placed inside a test chamber at a distance of 40 mm from a clean glass plate with a known optical transmission at 600 nm. The test specimen (3 mm thick by 28 mm diameter) is heated to 200° C. for 20 hrs, while the glass plate is kept at 80° C. with a circulating water bath. Any outgassing from the test specimen may condense on the glass plate to provide a fogged plate. After 20 hrs the glass plate is removed and characterized by measurement of transmittance at 600 nm. The ratio of the final glass plate transmittance to initial transmittance multiplied by 100% gives the fogging value as a % transmittance of the plate. The lower the value, the more condensable outgassing. 100% light transmission indicates no condensable outgassing has occurred.
Air oven aging (AOA) method.—AOA is defined as air oven aging at various times and temperatures per ISO 188 Method B. The oven temperature was 150° C. or 125° C. and samples were tested after 0, 500, 1000, 1500, 2000 hrs of exposure.
Tensile strength and elongation were measured using ISO 527 at an extension rate of 5 mm per minute.

### Compounding and Molding Methods

All polyamide resins for Masterbatch formation were dried at 90° C. for 12 h prior to extrusion. Resins for examples 2 and 3 were used directly as packaged without further drying. The mineral additives were used as received unless otherwise noted.
Compounding Method A Polymeric compositions were prepared by compounding in a 30 mm Coperion twin screw extruder (Coperion Inc., Ramsey N.J.). Some of all the ingredients were added through the rear feed throat (barrel 1) of the extruder, with some of Polymer A being side-fed into barrel 6 (of 9 barrels). Barrel temperatures were set between 230 and 320° C., resulting in melt temperatures 330-340° C. depending on the composition and extruder rate and the screw rpm.
Compounding Method B Polymeric compositions were prepared by compounding in a 30 mm Coperion twin-screw extruder. All ingredients were mixed together and added through the rear feed throat (barrel 1) of the extruder, Barrel temperatures were set at 300° C., resulting in melt temperatures 320-340° C. depending on the composition and extruder rate 18.1 Kg/hr and screw rate of 300 rpm.
Compounding Method C Polymeric compositions were prepared by compounding in a 30 mm Coperion ZSK-40 twin-screw extruder. All ingredients except the heat stabilizer and talc, if present, were mixed together and added through the rear feed throat (barrel 1) of the extruder. The heat stabilizer and talc, when present, were side-fed.
Compounding Method D Polymeric compositions were prepared by compounding in a 40 mm Coperion ZSK-40 twin-screw extruder. All ingredients were mixed together and added through the rear feed throat (barrel 1) of the extruder.
Molding Methods. Resins were molded into ISO test specimens on an Ergotech 125-320D 124 cm³, 30 mm molding machine (Demag Plastics Group, Inc., Strongville, Ohio). Resins used were equal to, or less than, 0.1% water. The melt temperature for Polyamide A and Polyamide B was 310° C., and mold temperatures were 80° C. unless otherwise noted.

Masterbatch 1—Preparation of a Polyamide A/Sepiolite Nanocomposite A masterbatch of Polyamide A containing 20 wt % Pangel® S-9 sepiolite was prepared using Compounding Method A. SEC characterization indicated the polymer Mₙ was 11370 and PDI=3.54. TEM analysis indicated the masterbatch formed a suitable nanocomposite. The sepiolite nanoparticles were well dispersed with some larger aggregates still present.

Masterbatch 2—Preparation of a Polyamide B/Sepiolite Nanocomposite A masterbatch sample of Polyamide B with 20 wt % Pangel® S-9 sepiolite was prepared using Compounding Method A. SEC characterization indicated the polymer Mₙ after extrusion was 20990 and PDI=2.04.

Masterbatch 3—Preparation of a polyamide 6,6/Sepiolite Nanocomposite A masterbatch sample of Zytel® 101 polyamide 6,6 and 20 wt % Pangel® S-9 sepiolite was prepared using Compounding Method D. TEM analysis indicated the masterbatch formed a suitable nanocomposite with the particles well dispersed and some larger aggregates still present.

### Example 1

This example illustrates the formation of a 3 wt % sepiolite nanocomposite composition with Cu species heat stabilizer. The components listed in Table 1 for Example 1 were blended using Compounding Method C. The heat stabilizer package used consisted of 11.1 wt % copper iodide. Thus, the example used 0.0444 wt % CuI. Melt viscosity retention of the sample is listed in Table 2.

### Comparative Examples A-D

Comparative Examples A-D components, listed in Table 1, were blended using Compounding method B. The melt viscosity retentions are listed in Table 2 and the condensable outgassing as characterized by fogging of glass plates are listed in Table 3. Differences between Example 1 and Comparative Examples are summarized below:

Comparative Example A: polyamide blend with no sepiolite or Cu species.
Comparative Example B: polyamide blend with Cu species but no sepiolite.
Comparative Example C: polyamide blend with Cu species but sepiolite replaced with 5 wt % Nyad® 5000 wollastonite).
Comparative Example D: polyamide blend with sepiolite but no Cu species.

TABLE 1
Compositions of Example 1 and Comparative Examples A-D.

| Materials^{a} | Comp A | Comp B | Comp C | Comp D | Ex 1 |
|---|---|---|---|---|---|
| Polyamide A | 49.9 | 49.7 | 47.15 | 36.3 | 35.7 |
| Polyamide B | 49.8 | 49.6 | 47.15 | 48.4 | 48.6 |
| Masterbatch 1 | — | — | — | 15 | 15 |
| (20 wt % sepiolite) | | | | | |
| Carbon black | 0.3 | 0.3 | 0.3 | 0.3 | 0.3 |
| Nyad 5000 | — | — | 5 | — | — |
| HS 7.1.1 S heat | — | 0.4 | 0.4 | — | 0.4 |
| stabilizer | | | | | |

^{a}parts totaling 100.

TABLE 2
Melt Viscosity Retention (MVR)^{a}

| Sample | Comp A | Comp B | Comp C | Comp D | Ex 1 |
|---|---|---|---|---|---|
| 5 min (Pa sec) | 73 | 79 | 70 | 81 | 76 |
| 10 min (Pa sec) | 61 | 63 | 54 | 69 | 65 |
| 15 min (Pa sec) | 52 | 42 | 40 | 57 | 52 |
| 20 min (Pa sec) | 46 | 18 | 17 | 51 | 43 |
| 25 min (Pa sec) | 40 | 14 | 10 | 45 | 40 |
| % MVR | 55 | 18 | 14 | 56 | 53 |
| at 25 min | | | | | |

^{a}run at 320° C.

The results indicate that Comparative Example A, having no copper species, has reasonable melt viscosity retention; whereas when the copper species is present (Comparative Example B) the melt viscosity retention drops significantly. When wollastonite, a common filler, is added along with the copper species (Comparative example C), the melt viscosity remains low. When sepiolite nanoparticles are present but no copper species (Comparative Example D) the melt viscosity retention is at a level comparable with the polyamide composition having no copper species present. When the polyamide is blended with copper species and sepiolite nanoparticles (Example 1), the melt viscosity retention remains at the level comparable with Comparable Example A (no copper species) or Comparative Example D (sepiolite only). Thus, Example 1 illustrates that the addition of sepiolite to the polyamide blend allows the addition of the copper species without experiencing a significant drop in melt viscosity retention. Other benefits of the presence of copper species and sepiolite, discussed below, can be achieved in Example 1.

A significant benefit is exhibited when the condensable outgassing of the composites of the Comparative Examples A-D and Example 1 are compared. Condensable outgassing of test specimens were measured according to the “Condensable Fogging Test for Automotive Lighting Applications” described above. The results are listed in Table 3. The higher the % transmittance the lower the condensable outgassing.

TABLE 3
Condensable Outgassing as measured by fogging of glass plate^{a}

| Sample | Comp A | Comp B | Comp C | Comp D | Ex 1 |
|---|---|---|---|---|---|
| % transmittance | 67 | 98 | 97 | 71 | 98 |
| % MVR^{b} | 55 | 18 | 14 | 56 | 53 |

^{a}sample heated to 200° C.; glass plate held at 80° C.; for 20 hr.
^{b}from Table 2.

The results indicate that Comparable Example B and C, and Example 1 have comparable and very low condensable outgassing characteristics. However, only Example 1 exhibits both high MVR and low condensable outgassing.

### Example 2

This example illustrates the formation of a 2.2 wt % sepiolite nanocomposite composition with copper heat stabilizer. The components listed in Table 4 for Example 2 were blended using Compounding Method C. Barrel temperature was set at 320° C. An extruder rate of 81.5 Kg/hr and screw rate of 375 rpm was used. Melt temperature of extrudate was 333° C. The heat stabilizer package used consisted of 11.1 wt % copper iodide. Thus, the example used 0.133 wt % CuI. The affects of air oven aging samples of example 2, using ISO 188 Method B, are listed in Tables 5 and 6.

### Comparative Example E

This comparative example is a control sample of a polyamide composition similar to Example 2 with no sepiolite present. The components listed in Table 4, Comp E, were blended using Compounding Method C. Conditions were the same as described for Example 2. The affects of air oven aging samples of comparative Example E, using ISO 188 Method B, are listed in Tables 5 and 6.

TABLE 4
Compositions of Example 2 and Comparative Example E.

| Material^{a} | Comp E | Ex 2 |
|---|---|---|
| Polyamide A | 25.62 | 16.35 |
| Polyamide B | 59.78 | 58.05 |
| Masterbatch 1 (20 wt % sepiolite) | — | 8.80 |
| TRX 301 terpolymer | 8 | 8 |
| Engage 8180 elastomer | 4 | 4 |
| HS 7.1.1 S heat stabilizer | 1.2 | 1.2 |
| Irganox ® 1010 antioxidant | 0.5 | 0.5 |
| LM-S#200 talc | 0.4 | 0.4 |
| PED 521 wax | 0.3 | 0.3 |
| NRD-47 (DDDA) | 0.2 | 0.2 |

^{a}parts totaling 100.

TABLE 5
Tensile Strength after air oven aging.

| | |
|---|---|
| | Tensile Strength |
| AOA^{a} | (Mpa) |

| (hr) | Comp E | Ex 2 |
|---|---|---|
| 0 | 73 | 75 |
| 500 | 75 | 75.5 |
| 1000 | 68 | 78 |
| 1500 | 52 | 72 |
| 2000 | 45 | 58 |

^{a}150° C.

TABLE 6
Elongation at break after air oven aging.

| | |
|---|---|
| | Elongation at |
| AOA^{a} | break (%) |

| (hr) | Comp E | Ex 2 |
|---|---|---|
| 0 | 8.2 | 8.6 |
| 500 | 5.8 | 5.9 |
| 1000 | 3.2 | 5.7 |
| 1500 | 2 | 3.2 |
| 2000 | 1.8 | 2.2 |

^{a}150° C.

The results indicate that tensile strength and elongation at break both are improved when the copper compound and sepiolite are present as compared to the Comparative Example E wherein only the copper compound is present.

### Example 3

This example illustrates the formation of a 2 wt % sepiolite nanocomposite composition with Cu heat stabilizer in polyamide 6,6. The components listed in Table 7 for Example 3 were blended using Compounding Method D. Barrel temperature was 280° C. Melt temperature of extrudate was 320° C. An extruder rate of 150 lb per hour and screw rate of 300 rpm was used.

The heat stabilizer package used consisted of 11.1 wt % copper iodide. Thus, the example used 0.033 wt % CuI. The affects of air oven aging samples of example 3, using ISO 188 Method B, are listed in Tables 8 and 9.

### Comparative Example F

This comparative example is a control sample of a polyamide composition similar to Example 3 with no sepiolite present. The components listed in Table 7, Comp F, were blended using Compounding Method D. Conditions were the same as described in Example 3. The affects of air oven aging samples of comparative Example F, using ISO 188 Method B, are listed in Tables 8 and 9.

TABLE 7
Compositions of Example 3 and Comparative Example E.

| Material^{a} | Comp F | Ex 3 |
|---|---|---|
| Zytel ® Polyamide 6,6 | 80.1 | 70.1 |
| Masterbatch 3 (20 wt % sepiolite) | — | 10.0 |
| TRX 301 | 8.5 | 8.5 |
| Engage 8180 (elastomer) | 11.0 | 11.0 |
| HS 7.1.1 S heat stabilizer | 0.3 | 0.3 |
| AL stearate PLT | 0.1 | 0.1 |

^{a}parts totaling 100

TABLE 8
Tensile Strength after air oven aging.

| | |
|---|---|
| | Tensile Strength |
| AOA^{a} | (Mpa) |

| (hr) | Comp F | Ex 3 |
|---|---|---|
| 0 | 46.37 | 52.02 |
| 500 | 48.77 | 55.34 |
| 1000 | 53.3 | 57.7 |
| 2000 | 47.4 | 54.9 |

^{a}125° C.

TABLE 9
Elongation at break after air oven aging.

| | |
|---|---|
| | Elongation at |
| AOA^{a} | break (%) |

| (hr) | Comp F | Ex 3 |
|---|---|---|
| 0 | 38.8 | 29.64 |
| 500 | 31.6 | 18.4 |
| 1000 | 10.5 | 21.2 |
| 2000 | 3.1 | 27.9 |

^{a}125° C.

The results indicate that the elongation at break is maintained in Example 3, wherein the copper heat stabilizer and sepiolite are present, whereas in Comparative Example F, wherein only the copper heat stabilizer is present, elongation at break dropped significantly with AOA.

What is claimed is:

1. A nanocomposite composition, comprising
(a) at least one thermoplastic polyamide;
(b) about 0.5 to about 5 wt % of unmodified sepiolite-type clay nanoparticles having widths and thicknesses of less than 50 nm; and
(c) about 0.001 to about 1.0 wt % of a copper species selected from Cu(I), Cu(II), or a mixture thereof;
based on the total weight of the nanocomposite composition.

2. The composition of claim 1 wherein the Cu species is about 0.01 to 0.5 wt %, based on a total weight of the nanocomposite composition, and is selected from the group consisting of copper iodide, copper bromide, copper chloride, copper fluoride; copper thiocyanate, copper nitrate, copper acetate, copper naphthenate, copper caprate, copper laurate, copper stearate, copper acetylacetonate, copper oxide (I) and copper oxide (II).

3. The composition of claim 1 wherein the Cu species is a copper halide selected from copper iodide, copper bromide, copper chloride, and copper fluoride.

4. The composition of claim 3 wherein the Cu species is copper iodide.

5. The composition of claim 1 additionally comprising about 0.01 to about 1.0 wt % of an metal halide salt selected from LiI, NaI, KI, MgI₂, KBr, and CaI₂.

6. The composition of claim 5 wherein the metal iodide salt is KI or KBr.

7. The composition of claim 1 wherein the polyamide is an aliphatic polyamide.

8. The composition of claim 1 wherein the polyamide is a semi-aromatic polyamide.

9. The composition of claim 8 wherein the semi-aromatic polyamide is selected from one or more homopolymers, copolymers, terpolymers, and higher polymers that are derived in part from monomers that contain divalent aromatic groups; and a blend of one or more aliphatic polyamides with one or more homopolymers, copolymers, terpolymers, or higher polymers that are derived in part from monomers containing divalent aromatic groups.

10. The composition of claim 8 wherein the semi-aromatic polyamide is selected from poly(m-xylylene adipamide) hexamethylene adipamide/hexamethylene terephthalamide copolyamide; hexamethylene terephthalamide/2-methylpentamethylene terephthalamide copolyamide; poly(dodecamethylene terephthalamide); poly(decamethylene terephthalamide); decamethylene terephthalamide/decamethylene dodecanoamide copolyamide; poly(nonamethylene terephthalamide); the polyamide of hexamethylene isophthalamide and hexamethylene adipamide; the polyamide of hexamethylene terephthalamide, hexamethylene isophthalamide, and hexamethylene adipamide; and a copolymer or mixture of these polymers.

11. The composition of claim 10 wherein the semi-aromatic polyamide is selected from hexamethylene terephthalamide/2-methylpentamethylene terephthalamide copolyamide and hexamethylene adipamide/hexamethylene terephthalamide copolyamide.

12. The composition of claim 1 further comprising a polymeric toughening agent that is present at about 2 to about 30 wt % based on the total composition.

13. The composition of claim 12 wherein the polymeric toughening agent contains functional groups selected from carboxyl, anhydride, amine, epoxy, halogen, and mixtures of these.

14. The composition of claim 12 wherein the polymeric toughening agent is an ionomer of units derived from alpha-olefin having the formula RCH═CH₂ wherein R is H or alkyl having from 1 to 8 carbon atoms and from 0.2 to 25 mole percent of units derived from an alpha, beta-ethylenically unsaturated mono- or dicarboxylic acid, at least 10% of the acid groups of said units being neutralized by metal ions having a valence of from 1 to 3, inclusive.

15. The composition of claim 1 further comprising about 0.1 to about 50 weight percent, based on the total of all ingredients in the composition, of a reinforcing agent, exclusive of the sepiolite-type clay, selected from: kaolin clay, talc, wollastonite, mica, calcium carbonate, glass fibers, milled glass, solid and hollow glass spheres, carbon black, carbon fiber; titanium dioxide, aramid fibers, fibrils and fibrids, and mixtures thereof.

16. The composition of claim 1 wherein the at least one thermoplastic polyamide (a) is selected from polyamide 6,6; polyamide 6; a copolyamide of terephthalic acid, hexamethylenediamine, and 2-methyl-pentamethylenediamine; a copolyamide made from terephthalic acid, adipic acid, and hexamethylenediamine; the Cu species (c) is present in an amount from about 0.01 to about 1.0 wt %; and wherein the composition further comprises (d) 0 to about 20 wt % polymeric toughening agent comprising at least one of
(iii) an ethylene/propylene/hexadiene copolymer grafted with maleic anhydride; and
(iv) a copolymer of ethylene and acrylic or methacrylic acid that is at least 10% neutralized by metal ions
wherein the weight percentages are based on the total weight of the nanocomposite composition.

17. An article of manufacture comprising the composition of claim 1.

18. The article of claim 17 wherein the article is an automobile component.

19. The article of claim 17 wherein the automobile component is selected from a radiator end tank, air intake manifold, air induction resonator, front end module, engine cooling water outlet, fuel rail, ignition coil, engine cover, switch, handle, seat belt component, air bag container, bezel, fog lamp housing, pedal, pedal box, seat system, wheel cover, sun roof surround, door handles, and fuel filler flaps.

20. The article of claim 17 wherein the article is selected from a connector, coil former, motor armature insulator, light housing, plug, switch, switchgear, housing, relay, circuit breaker component, terminal strip, printed circuit board, and housing for electronic equipment.

21. The article of claim 17 wherein the article is selected from a power tool housing, sports equipment article, lighter, kitchen utensil, phone jack, small appliance, large appliance, furniture, eyeglass frame, packaging film, gear, pulley, bearing, bearing cage, valve, stadium seat, sliding rail for a conveyer, castor, HVAC boiler manifold, diverting valve, and pump housing.

22. The article of claim 21 wherein the sports equipment article is selected from a ski boot, ski binding, ice skate, roller skate, and tennis racket.
